(19) United States
(12) Patent Application Publication
(10) Pub. No.: US 2009/0078573 A1
(43) Pub. Date: Mar. 26, 2009

(54) SOLID-ELECTROLYTE GAS SENSOR ELEMENT, INCLUDING A PUMP CELL AND A REFERENCE GAS CHANNEL

(76) Inventors: Thomas Wahl, Pforzheim (DE); Joerg Ziegler, Rutesheim (DE); Bernd Schumann, Rutesheim (DE); Stefan Nufer, Stuttgart (DE)

Correspondence Address: KENYON & KENYON LLP, ONE BROADWAY, NEW YORK, NY, 10004, US

(21) Appl. No.: 12/092,644

(22) PCT Filed: Oct. 20, 2006
(86) PCT No.: PCT/EP06/67597

§ 371 Date: Oct. 7, 2008

(30) Foreign Application Priority Data
Nov. 3, 2005 (DE) 10 2005 052 430.3

(51) Int. Cl. G01N 27/26

(52) U.S. Cl. 204/424

(57) ABSTRACT

A sensor element for determining gas components in measuring gas mixtures, particularly gas components in exhaust gases of combustion devices, having a measuring chamber that is in gas-conducting connection with the measuring gas mixture, and having a solid electrolyte which connects a pump electrode, situated in the measuring chamber, and a pump counterelectrode while conducting oxygen ions, in order to set the oxygen content in the measuring chamber. This sensor element stands out by having the pump counterelectrode situated in a reference gas chamber.

### FIELD OF THE INVENTION

The present invention relates to a sensor element.

### BACKGROUND INFORMATION

Gas sensors are used for identifying gas components and/or for determining the gas concentration in measuring gas mixtures, and they generate a measuring signal while taking into account the oxygen content in a measuring chamber that is in gas-conducting contact with the measuring gas.

So-called lambda probes are one type of such sensors, In their case, limiting current probes are involved, based on a ceramic solid electrolyte which connects two electrodes in an ion-conducting manner. The measuring chamber is preferably equipped with a diffusion barrier which steadies and also limits the access of the measuring gas to the measuring chamber.

In order to set the oxygen content in the measuring chamber, the two electrodes are able to have applied to them an electrical pump voltage, using an appropriate circuit. The measure for the oxygen ion current, in this instance, between the pump electrode situated in the measuring chamber and the pump counterelectrode situated outside the measuring chamber, is the electric current flowing between the two electrodes. Depending on a lack of oxygen or an excess of oxygen in the measuring chamber, which means a rich or a lean mixture in exhaust gases, a corresponding voltage is applied to the two electrodes by the circuit. This voltage causes an electrical field between the two electrodes, whose field forces cause an oxygen ion current through the solid electrolyte.

A change, caused by the measuring gas flowing into the measuring chamber via the diffusion barrier, in the oxygen concentration, that is set to be constant in the measuring chamber, may be determined using a so-called measuring cell. It is preferably also made up of a solid electrolyte and a measuring electrode situated in the measuring chamber and a reference electrode exposed to a reference gas, preferably air. The voltage present between the measuring electrode and the reference electrode is a measure for the difference in the oxygen concentrations between the gas mixture in the measuring chamber and the reference gas. When the oxygen content in the reference gas is known, that is, approximately 21% in the case of air, the absolute oxygen concentration in the measuring chamber is also known upon rectification of the concentration.

Such gas sensors, frequently also called probes, are used for the regulation of combustion processes. They are used for putting a value on the exhaust gases thus created, whereby, using appropriate further measures, already a massive reduction in pollutants is able to be achieved, for instance, in the case of internal combustion engines. Based on the increasing importance of pollutant emissions, however, it would be desirable to get a better grip on mobile as well as immobile combustion processes.

### SUMMARY

Example embodiments of the present invention provide for improving a sensor of the type mentioned at the outset.

Accordingly, example embodiments of the present invention provide a sensor element for determining gas components in measuring gas mixtures, particularly gas components in exhaust gases of combustion devices, having a measuring chamber that is in gas-conducting connection with the measuring gas mixture, and having a solid electrolyte which connects a pump electrode situated in the measuring chamber and a pump counterelectrode while conducting oxygen ions, in order to set the oxygen content in the measuring chamber. This sensor element stands out by having the pump counterelectrode situated in a reference gas chamber.

This positioning of the pump counterelectrode in a reference gas chamber is based on the realization that one may achieve a very great signal steadiness of the probe, especially at the lambda=1 transition. The lambda=1 ripple of the pump current, used as the measuring signal, which has been known up to now from the related art, may be greatly reduced using a sensor element thus designed. The reason is particularly that the gas change between rich and lean in the measuring gas has no influence on the pump counterelectrode situated in the reference gas chamber for the oxygen ion takeup, for the oxygen supply of the measuring chamber. For, the strongly changing oxidation and reduction processes, especially in the lambda=1 transition, are not able to have any effect on the quantitative change that influences the measuring signal, in the free oxygen ions available for the pump process at the surface of the pump counterelectrode, because of the gas-tight separation between the measuring gas and the pump counterelectrode.

Because of a gas-conducting connection of the reference gas chamber to the ambient air, it may not only be assured that this measuring signal stabilization is ensured over the entire service life of the sensor element. But a clearly broadened field of use of the sensor element may furthermore be made available, in the direction to very rich, that is, oxygen-poor measuring gas mixtures.

On the condition that the reference gas chamber that is connected to the ambient air is dimensioned in such a way that the limiting current at the pump counterelectrode is sufficiently large to produce the transport of O²⁻ to the pump electrode in the measuring gas chamber, it may be assured in addition that, even in extremely rich exhaust gases, there cannot be any damage to the sensor element by decomposition of the solid electrolyte, and no brown coloration going along with that, because of a reaction ZrO₂+4e⁻−>Zr+2O²⁻). In response to suitable dimensioning of the reference gas chamber, the pump counterelectrode that is in connection with the ambient air may also make available sufficient O²⁻, even in measurements in very rich exhaust gas mixtures, in order to oxidize completely the rich exhaust gas present at the pump electrode in the measuring chamber. That being the case, the device according to example embodiments of the present invention will be able to determine the λ value reliably even in very rich gas mixtures and over longer time periods.

In order to reduce the production effort and also the production costs of such a sensor element, in appropriately modified example embodiments, for example, the pump electrode may be developed in common with a first measuring electrode and/or the pump counterelectrode may be developed in common with a second measuring electrode. In the respectively common development of the pump electrode with the first measuring electrode in the measuring chamber, and the pump counterelectrode with the second measuring electrode in a reference gas chamber, also called a reference electrode, the number of electrodes may even be reduced to two, if the material are selected suitably. The wiring configuration of the sensor element, in this instance, has to be adapted corresponding to the number of electrodes, and in dependence upon the example embodiment.

In an example embodiment, the pump counterelectrode may be positioned close to the heating element, so that the pump counterelectrode is able to be brought rapidly to the operating temperature, and is thus ready to be used without interference. In this connection, it is especially advantageous if a heat transfer, that is as free as possible of interference, between the heating element and the measuring cell can be provided. For this purpose, in an example embodiment, a part of the reference gas chamber developed between the heating element and the pump counterelectrode is developed to be as small as possible, taking into account a sufficient oxygen supply even for rich mixtures. To do this, one might want to consider a tapering at the end of a large-volume reference gas chamber in that region in which the pump counterelectrode is situated.

A further positive influencing of the measuring signal may be accomplished by a diffusion barrier preconnected to the measuring chamber in the direction towards the measuring gas mixture, which, regarded over its effective cross section, forms a substantially equally large diffusion resistance before the surface of the pump electrode facing it. One may thereby achieve a uniform ageing of the pump electrode over its entire effective cross section. This is based on the fact that, as seen over the effective cross section of the pump electrode, all parts have approximately the same participation in the formation or reduction of oxygen ions for keeping constant the oxygen proportion in the gas in the measuring chamber.

Example embodiments of the present invention are explained in more detail on the basis of the drawings and the description referring to it below.

### BRIEF DESCRIPTION OF THE DRAWINGS

FIGS. 1 to 3 are schematic views of a sensor element construction in different sectional representations.

### DETAILED DESCRIPTION

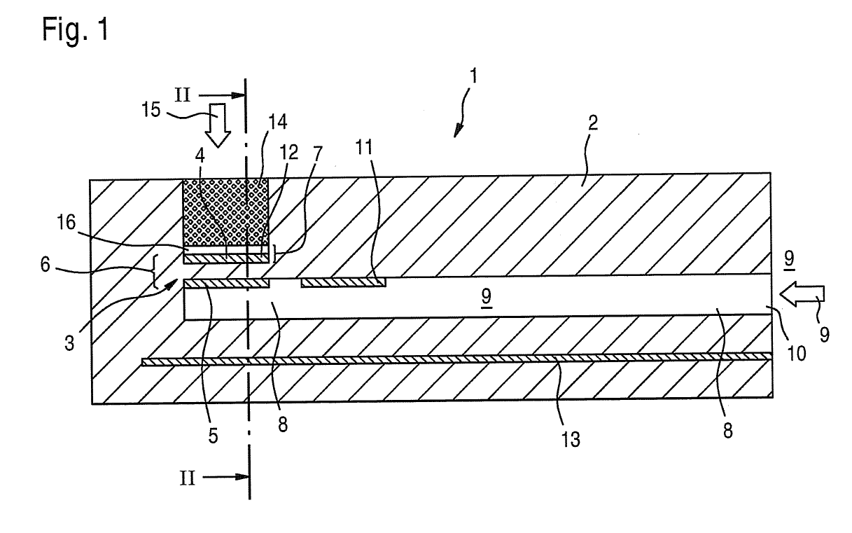

In detail, FIG. 1 shows a schematic representation of a longitudinal section through a sensor element according to the present invention. Sensor element 1 has an elongated form, and is preferably constructed based on yttrium-stabilized zirconium dioxide which, besides the function of a solid electrolyte 3, also has the function of a carrier element 2, at the same time. Solid electrolyte 3, together with a pump electrode 4 and a pump counterelectrode 5 forms a pump cell 6 that is suitable for oxygen ion transfer.

For this, pump electrode 4 is situated in a measuring chamber 7, and is connected via solid electrolyte 3 which conducts oxygen ions to a pump counterelectrode 5 situated in a reference gas chamber 8, according to example embodiments of the present invention, so as to provide a constant oxygen concentration in measuring chamber 7. The positioning of pump counterelectrode 5 in a reference gas, in the current example the ambient air, has the effect of good signal steadiness of the probe, especially at a lambda λ=1 transition of the measuring gas mixture.

Negative effects on the measuring signal, as are observed in the devices known up to now as non-monoticity of the oxygen signal during the transition of the exhaust gas composition through λ=1, which is attributed to the positioning of the pump counterelectrode in the measuring gas, may be switched off using this sensor element construction.

An additional advantage of the present sensor element is a clearly broader field of application of the sensor element, in response to a suitable dimensioning of reference gas chamber 8. For instance, in the case of positioning such a sensor element in an exhaust gas tract, the pump counterelectrode, even in the case of very rich exhaust gas, is able to supply sufficient O²⁻ from O₂ according to O₂+2e⁻−>2O²⁻ to the pump electrode, so as to ensure a reliable signal. To do this, however, the correct dimensioning of the reference air channel is important. That is, the limiting current at the pump counterelectrode has to be sufficiently large to ensure the transport of the O²⁻ & to the pump electrode. The richer the gas mixture that is to be measured, the larger the limiting current for the reference air channel has to be selected, because more O₂ has to be additionally supplied.

However, if the pump counterelectrode were situated in the exhaust gas, then, in rich exhaust gas, O²⁻ could only be obtained from CO₂ (CO₂+2e⁻−>CO+O²⁻) or H₂O(H₂O+2e⁻−>H₂+O²⁻. For these reactions, a clearly higher pump voltage would be required. If after such reactions sufficient O²⁻ could no longer be formed (above all, there would be the danger in the case of very rich mixtures, because in that case a great deal of O²⁻ is required), there would be decomposition of the ZrO₂ ceramic (ZrO₂+4e⁻−>Zr+2O²⁻), and there would be damage to the sensor element (brown discoloration). Such damage to the sensor element may, however, be prevented by the design according to example embodiments of the present invention.

Sensor element 1 according to FIG. 1 moreover has a reference electrode 11 and a measuring electrode 12, via which the oxygen concentration in measuring chamber 7 may be ascertained in conjunction with an appropriate circuit. As a function of the oxygen concentration value thus ascertained, pump counterelectrode 5 and pump electrode 4 are then able to have a pump voltage applied to them which causes an oxygen ion current through the solid electrolyte, that adjusts the concentration deviation in the measuring chamber.

In an example embodiment, pump electrode 4 and measuring electrode 12 are developed in common. In the present case, pump counterelectrode 5 and reference electrode 11 are developed separately, but in modified example embodiments they might also be developed in common, for instance, for reasons of savings. Alternatively, the reference electrode may be operated in an additional reference gas chamber, in deviation from FIG. 1. Then, the possibility exists of operating the reference electrode also as a pumped reference electrode. In order to be able to bring the sensor element, but particularly pump counterelectrode 5, to the operating temperature as quickly as possible, a heating element 13 is situated in sensor element 1 below reference gas chamber 8.

In order to be able to reduce the effects of the great flow fluctuations, that appear especially in exhaust gas systems of internal combustion engines, on the measuring signals of the sensor element, sensor element 1, as in FIG. 1, additionally has a diffusion barrier 14. This is developed such that, as seen over its effective cross section, it substantially develops an equally great diffusion resistance before the surface of pump electrode 4 facing it. In FIG. 1, the measuring gas mixture is shown symbolically by arrow 15. In order to effect an even more rapid, uniform distribution of the gas concentration in measuring chamber 7, a gas chamber 16 is additionally formed in this example embodiment between diffusion barrier 14 and pump electrode 4.

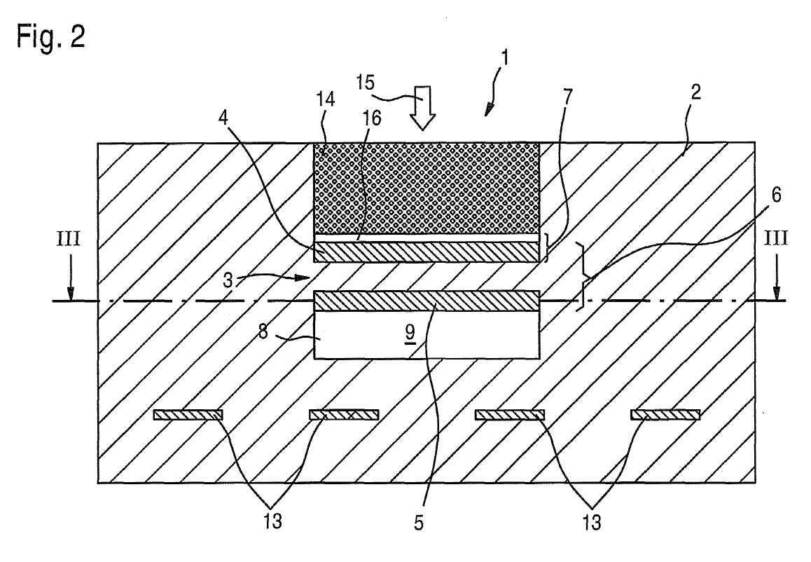

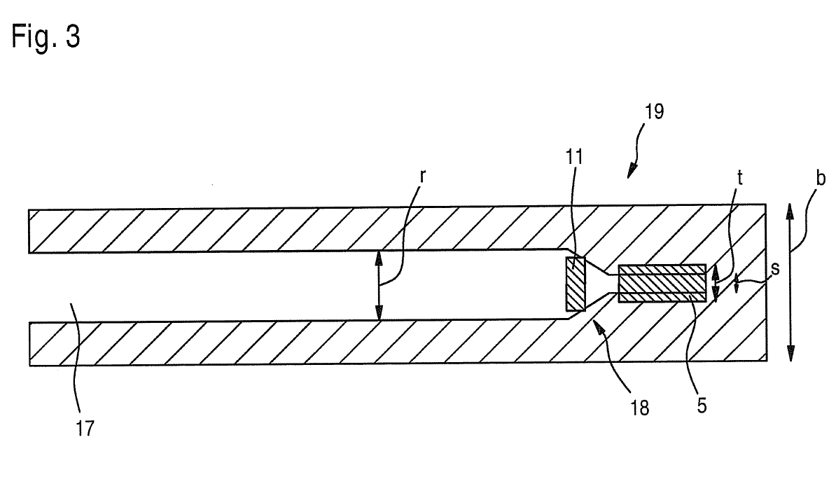

Additional design features of this sensor element is shown in FIG. 2 in a cross sectional representation II-II marked in FIG. 1. FIG. 3 shows a cross sectional representation through sensor element 1 corresponding to line III-III in FIG. 2. In this exemplary embodiment, reference air channel 8 is designed so that it has a broad supply region 17 which ends in a tapering 18 in measuring cell region 19, in order to ensure as good as possible a heat conduction of the heating element to the measuring cell.

In order to be able to ensure a sufficient supply of oxygen to the pump counterelectrode of the measuring cell of sensor element 1, the following relationship is proposed, for instance:

b>r>s and t≧s, and s≦b/4.

The following estimation may be used to estimate the required limiting current of the reference air channel on the air:

The reference air channel has to be dimensioned so that I_{RK}(air)≧|Iₚ(richexhaustgas)| applies.

I_{RK}(air): Limiting current for cathodically operated pump counterelectrode on air |Iₚ(richexhaustgas)|: Amount of pump current at the pump electrode for rich exhaust gas. The smaller λ, the greater |Iₚ(richexhaustgas)|.

Iᵣₑₗ=|Iₚ(richexhaustgas)|/Iₚ(air)

Iₚ(air): Limiting current for cathodically driven pump electrode in air

This makes I_{RK}(air)≧Iᵣₑₗ*I_{P}(air) valid

In the following table, Iᵣₑₗ is determined up to λ=0,4 (Assumption: The C:H-ratio in the fuel is 1:2; this is about an ideal rich exhaust gas, i.e. the rich exhaust gas is composed only of CO, H₂, CO₂, H₂O und N₂).

| λ | Iᵣₑₗ(bei K_{P} = 3.5) | Iᵣₑₗ(bei K_{P} = 2) |
|---|---|---|
| 0.8 | 0.9 | 1.1 |
| 0.7 | 1.7 | 1.9 |
| 0.6 | 2.7 | 2.9 |
| 0.5 | 4.0 | 4.2 |
| 0.4 | 5.8 | 5.9 |

Iᵣₑₗ is calculated for two different rich exhaust gases: K_{P} (equilibrium constant for water equilibrium)=3.5 corresponds to a typical engine exhaust gas and K_{P}=2 corresponds to a rich exhaust gas that is rich in H₂.

1-9. (canceled)

10. A sensor element for determining gas components in measuring gas mixtures, comprising:
a measuring chamber in gas-conducting connection with the measuring gas mixture;
a pump electrode arranged in the measuring chamber;
a pump counterelectrode arranged in a reference gas chamber; and
a solid electrolyte which connects the pump electrode and the pump counterelectrode while conducting oxygen ions to set an oxygen content in the measuring chamber.

11. The sensor element according to claim 10, wherein the sensor element is configured to determine gas components in an exhaust gas of a combustion device.

12. The sensor element according to claim 10, wherein the reference gas chamber is in gas-conducting connection with ambient air.

13. The sensor element according to claim 10, wherein the reference gas chamber is dimensioned such that a limiting current at the pump counterelectrode is sufficiently great to ensure transport of O2− through the solid electrolyte to the pump electrode in the measuring gas chamber even in extreme rich exhaust gases.

14. The sensor element according to claim 10, wherein the pump electrode is arranged in common with a first measuring electrode.

15. The sensor element according to claim 10, wherein the pump counterelectrode arranged in common with a second measuring electrode.

16. The sensor element according to claim 10, wherein the reference electrode is in a separate reference gas chamber and is operable as a pumped reference.

17. The sensor element according to claim 10, wherein the pump counterelectrode is arranged close to a heating element, and the pump counterelectrode and the measuring chamber are rapidly at an operating temperature.

18. The sensor element according to claim 10, further comprising a diffusion barrier connected upstream of the measuring chamber in a direction towards a measuring gas region.

19. The sensor element according to claim 18, wherein, as seen over an effective cross section, the diffusion barrier is adapted to provide an equally great diffusion resistance before a surface of pump electrode facing it.
